(19) United States
(12) Patent Application Publication
(10) Pub. No.: US 2003/0018660 A1
(43) Pub. Date: Jan. 23, 2003

(54) Method and apparatus for instance based data transformation

(75) Inventors: Thomas J. Martin, Fremont, CA (US); Richard K. Y. Koo, Redwood City, CA (US)

Correspondence Address: NIXON PEABODY, LLP, 8180 GREENSBORO DRIVE, SUITE 800, MCLEAN, VA, 22102, US

(73) Assignee: VITRIA TECHNOLOGY, INC.

(21) Appl. No.: 10/183,567

(22) Filed: Jun. 28, 2002

Related U.S. Application Data
(60) Provisional application No. 60/302,179, filed on Jun. 29, 2001.

(51) Int. Cl. G06F 15/00

(52) U.S. Cl. 707/500

(57) ABSTRACT

A method of defining a desired transformation from input data to output data from plural example documents, each having at least one data element, and data storage media with computer executable instructions for defining a desired transformation. In one embodiment, the method includes the steps of determining a data element definition including an element name and a structure for each data element of a first example document, determining a data element definition including an element name and a structure for each data element of a second example document, correlating the data element definitions of the first and second example documents to obtain a pattern set with data element definitions encompassing both example documents, and mapping the data element definitions of the pattern set to desired output data.

### RELATED APPLICATION DATA

This application claims priority to U.S. Provisional Application Serial No. 60/302,179 filed Jun. 29, 2001, the contents of which are incorporated herein by reference.

### BACKGROUND OF THE INVENTION

1. Field of the Invention

The present invention is directed to a method and apparatus for transforming input data to output data. In particular, the present invention is directed to a method and apparatus for transformation where a pattern set is generated from one or more example documents.

2. Description of Related Art

A data transformation engine takes input data in one form and converts it to output data. A data transformation as used herein, can be quite simple, for example, where the output data is a copy of the input data. The data transformation can also be quite complex, for example, where the value of the output data is derived by a complex mathematical formula applied to the input data, or where the output data is derived by enriching the input data with reference data stored in a relational database or other system. Thus, a transformation can cause the output data to be different both in its syntax, as well as its value, from the input data.

The data transformation can be attained via custom computer code written in a computer language like C++, Java, COBOL, or BASIC. This approach, while still prevalent, is increasingly supplanted by newer graphical oriented transformation tools. The advantage of the graphical oriented tools over custom computer code is that they allow non-programmers to define and specify data transformations.

These graphical tools typically display the structures of the input data and output data, and allow the user to define the desired transformation between the input data and the output data via direct manipulation. The desired transformation can range from a simple assignment operation (i.e., copying the value of some input data into some output data) to arbitrary functional or procedural invocations. A normalization of a date value in the input data to a value that is based on Universal Coordinated Time would be one example of transformation. Another example is the conversion of input data in EBCDIC format to output data in Unicode format.

Although graphical transformation tools have enabled non-programmers to specify transformations, they continue to require considerable technical skills. One reason is that known tools are schema-based. A schema is a formal definition of the structure of a document, and is generally stored in a data dictionary. For instance, for an airline reservation system, one can expect a schema defining flight reservations, flight schedules, airplanes, etc. Since schemas are almost always parsed by computer code, schemas are written in schema definition languages. XML DTD, OMG IDL, COBOL Copybook are well-known schema definition languages.

In order to foster interoperability and sharing, many standard bodies define schemas for their respective domains of influence. There are many such examples. One well-known example is the XHTML schema defined by W3C to describe the set of valid HTML web pages. Another example is the set of schemas defined by the RosettaNet standard body that covers a wide range of definitions in the high tech manufacturing domain. In the above regard, the published international application number PCT/US01/00586 directed to a system and method for schema evolution in an e-commerce network is noted for disclosing the background and use of schemas generally.

Although there is no requirement that schema definitions be complex or large, many schema definitions promoted by the standard bodies are in fact, very complex and large. This is a simple reflection of the standard bodies' desire for complete and general coverage of their respective domains. Nevertheless, the complexity of these schemas poses a usability challenge to schema-based transformation tools. In other words, even when using graphical transformation tools, the user must filter out specific elements required for the data transformation from the all encompassing schema.

### SUMMARY OF THE INVENTION

The present inventors have recognized that when defining transformations, it would be very desirable to have the option of ignoring the general and complex schema and to concentrate on the smaller set of data which are simpler and specifically relevant to the desired transformation. For instance, when defining transformations of web pages, the present inventors recognized that it would be desirable to have the option to ignore the web page schema, i.e. XHTML that is general and complex, and to concentrate on the smaller set of web pages themselves, which are specific and simpler. In another instance, when defining transformation of purchase orders used in a particular business or commerce environment, the present inventors recognized that it would be desirable to have the option to ignore the general and complex schema associated with the Electronic Data Interchange (EDI), and to concentrate on the smaller set of purchase orders themselves which are commonly used in the particular business or commerce environment. This option of ignoring the general and complex schema however, is not available from present schema-based transformation tools.

In view of the foregoing, an advantage of the present invention is in providing a method and apparatus for defining a desired transformation from input data to output data from plural example documents instead of using schema definitions which are typically large and complex.

Another advantage of the present invention is in providing a method and apparatus for deriving a pattern set from plural example documents which can be used for defining a transformation so that schema definitions are not required.

These and other advantages are attained in accordance with one embodiment of the present invention by a method of defining a desired transformation from input data to output data from plural example documents, each having at least one data element, the method including the steps of determining a data element definition including an element name and a structure for each data element of a first example document, determining a data element definition including an element name and a structure for each data element of a second example document, correlating the data element definitions of the first and second example documents to obtain a pattern set with data element definitions encompassing both example documents, and mapping the data element definitions of the pattern set to desired output data.

In accordance with another embodiment, the method also includes the steps of correlating the data element definitions into sets of data element definitions having the same element name, and generating a structure for each set of data element definitions having the same element name that encompasses all of the structures in the corresponding set of data element definitions. In this regard, the method may include the step of generating a structure that is the same as the structures in a corresponding set of data element definitions when all of the structures in the corresponding set of data element definitions are the same. Alternatively, the method may include the step of generating a structure that is a union of the structures in a corresponding set of data element definitions when not all of the structures in the corresponding set of data element definitions are the same.

In accordance with another embodiment, the present method may further include the step of determining a data element definition including an element name and a structure for each data element of a third example document, and the step of correlating the data element definitions of the third example document with the pattern set. The pattern set may then be refined to obtain a pattern set with data element definitions encompassing the third example document. In this regard, the pattern set may be refined by generating a sub-pattern set of a sub-element nested in a data element of the third example document. In another embodiment of the present method, the step of refining the pattern set may include generating sub-elements to add structure to a data string of a data element, determining data element definitions of the sub-elements, generating a sub-pattern set based on data element definitions of the sub-elements, and expanding the pattern set by integrating the generated sub-pattern set into the pattern set. Moreover, in any of the embodiments, the example document may be an input document and/or an output document, or another type of document.

In accordance with another embodiment of the present invention, a method of deriving a pattern set from plural example documents is provided, each having at least one data element, the method including the steps of determining a data element definition of each data element in a first set of example documents, generating an initial pattern set including the data element definitions from the first set of example documents, determining a data element definition of a subsequent set of example documents, and refining the initial pattern set to include data element definitions of the subsequent set of example documents. In this regard, the data element definitions each preferably include an element name and a structure and the method includes the steps of correlating the data element definitions into sets of data element definitions having the same element name, and generating a structure for each set of data element definitions having the same element name that encompasses all of the structures in the corresponding set of data element definitions.

In accordance with another aspect, the present invention is also directed to a data storage media with computer executable instructions for defining a desired transformation and a data storage media for deriving a pattern set from plural example documents.

These and other advantages and features of the present invention will become more apparent from the following detailed description of the preferred embodiments of the present invention when viewed in conjunction with the accompanying drawings.

### BRIEF DESCRIPTION OF THE DRAWINGS

FIG. 1 illustrates an example document which may be used in accordance with the present invention to obtain a pattern set for defining a desired transformation.

FIG. 2 is a schematic illustration of plural example documents with data elements that may be used to obtain and refine a pattern set.

FIG. 3 is a schematic illustration of a pattern set obtained from plural example documents, and a sub-pattern set that may be used to refine the pattern set.

FIG. 4 is a flow diagram illustrating a method in accordance with one embodiment of the present invention.

FIG. 5 is a schematic illustration of another application of the present invention used to obtain a pattern set.

FIGS. 6A to 6E each illustrate a step in using a graphical transformation tool in accordance with the present method which is implemented via a programmable general purpose computer.

FIG. 7 illustrates the graphical transformation tool being used to import a document type definition (DTD) to obtain a pattern set.

FIG. 8 illustrates an input data field of the graphical transformation tool with data elements of an XML document instance displayed therein.

FIG. 9 illustrates an input data field of the graphical transformation tool with data elements of an imported XML Document displayed therein.

### GLOSSARY

Data Dictionary—A file that defines the basic organization of a database or file.

Data Element—Components of an example document providing information regarding the document or instructions thereon.

Data Element Definition—Components of a data element including an element name and a structure.

Document Type Definition (DTD)—A collection of XML declarations that, as a collection, defines the legal structure, elements, and attributes that are available for use in a document that complies to the DTD.

Element Name—A sequence of one or more characters that encloses element data, which may have arbitrary syntax or may contain nested elements.

Example Document—A document with one or more data elements.

Graphical Transformation Tool—A computer implemented tool with a user interface for allowing graphical transformation of input data to output data, or vice versa.

Pattern Set—A collection of data element definitions derived from a collection of example documents.

Schema—A formal definition of a document structure typically stored in a data dictionary.

Structure—Description of an element or sub-element.

Sub-element—A data element which is nested in another data element.

Sub-pattern Set—A collection of data element definitions associated with one or more data element of a pattern set to allow for a hierarchical expansion of the pattern set.

Transformation—Any change or manipulation of a data element from input data to output data, or vice versa.

### DETAILED DESCRIPTION OF THE PREFERRED EMBODIMENT

The present invention provides a method and apparatus for defining a desired transformation from input data to output data from plural example documents, which may be electronic documents, thereby eliminating the various disadvantages associated with using large and complicated schema definitions as discussed previously. As explained herein below, this is attained by deriving what is referred to herein as a “pattern set” from plural example documents which are used to define a transformation so that schema definitions are not required. It should initially be noted that as used herein, “example documents” may be any type of documents including input documents and/or output documents.

In particular, an input document may be any document that corresponds to the input data used in the transformation, whereas an output document may be any document that corresponds to the output data that results from the transformation. For instance, in one example case, data from a customer having a certain format may be transformed to format of the purchaser. In such an example, the input document may be a purchase order which is in a format used by the customer, while the output document may be a purchase order which is in the format the vendor expects to see and can easily process. Of course, one or both types of documents, one of each type of document, or other types of documents, may be used in accordance with the present invention to derive the pattern set as described in further detail below. For instance, the example documents may be input documents, output documents, a combination of both, or combination of input or output documents with other types of documents, and so forth.

It should also be noted that the first application of the present invention is illustrated below in the context of stock transactions where the example documents are purchase orders with input data in XML format for transacting a particular stock. However, it should be noted that the discussion below presents merely one example and that the present invention is not limited to XML and stock purchase applications but may be used in any appropriate applications where transformation of input data to output data is desired. Thus, the example documents may be any type of documents including input documents and/or output documents used in any context or application.

As used herein, the phrase “pattern set” refers to a collection of data element definitions derived from a collection of example documents, again, the example documents being any type of documents including input documents and/or output documents. FIG. 1 shows a first example document 10 having a plurality of data elements 12, each data element has a data element definition consisting of two parts: an element name 14 and a structure 16. The element name 14 generally identifies the element. It should be evident to one of ordinary skill in the computer arts that in the illustrated application, the element name 14 of the data element definitions are XML tags. Thus, in the illustrated first example document 10 of FIG. 1, the first data element definition shown includes element name 14 identified by the XML tags “<name>” and “</name>” while the data element definition of the second data element includes element name 14 identified by the XML tags “<last_value>” and “</last_value>”.

The structure 16 can generally be thought of as the structure or category of the associated name. For instance, in the first data element shown in the first example document 10 of FIG. 1, the structure of name is the registered name of the company, in this case, “ACME Corp.” However, other structures of names may have been provided, for instance, a ticker symbol, or other alias of the company. The structure 16 for a corresponding data element definition is most clearly illustrated in the third data element having the element name 14 “change”. As can be seen, the third data element has the data string “+2.50” and “+5%” between the XML tags. Thus, the data element definition of the element named “change” has two different structures, one being expressed as the amount of change by the character string “+2.50” and the other being expressed as the percentage of change by the character string “+5%”. In this regard, it should be noted that the structure of the data element definition refers to the type of data or character string provided by the particular name and not the numerical values shown which are merely provided as an example. Correspondingly, each data element definition includes an element name 14 and one or more structures 16.

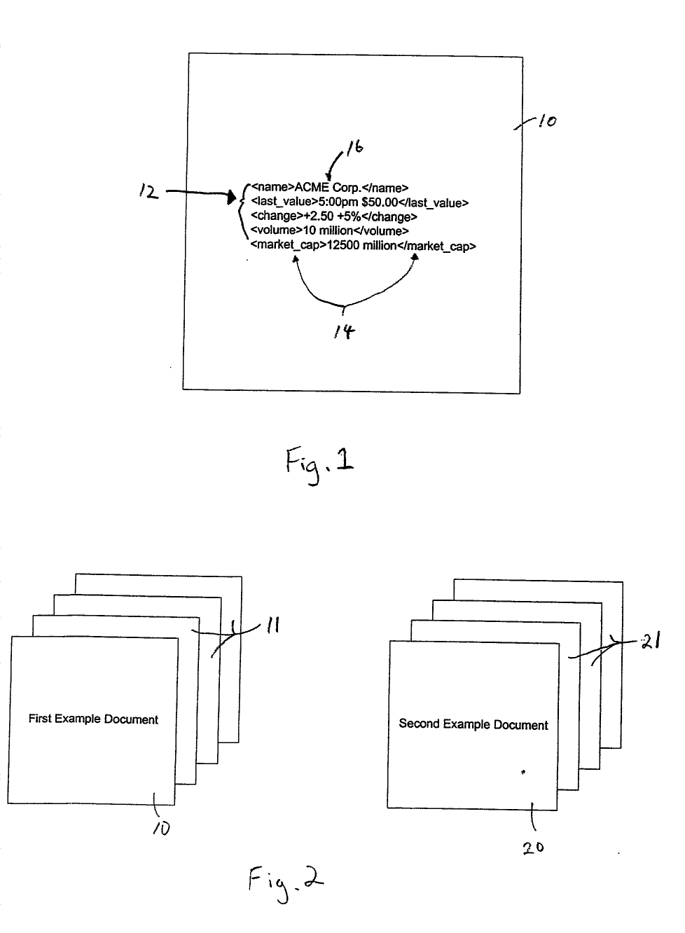

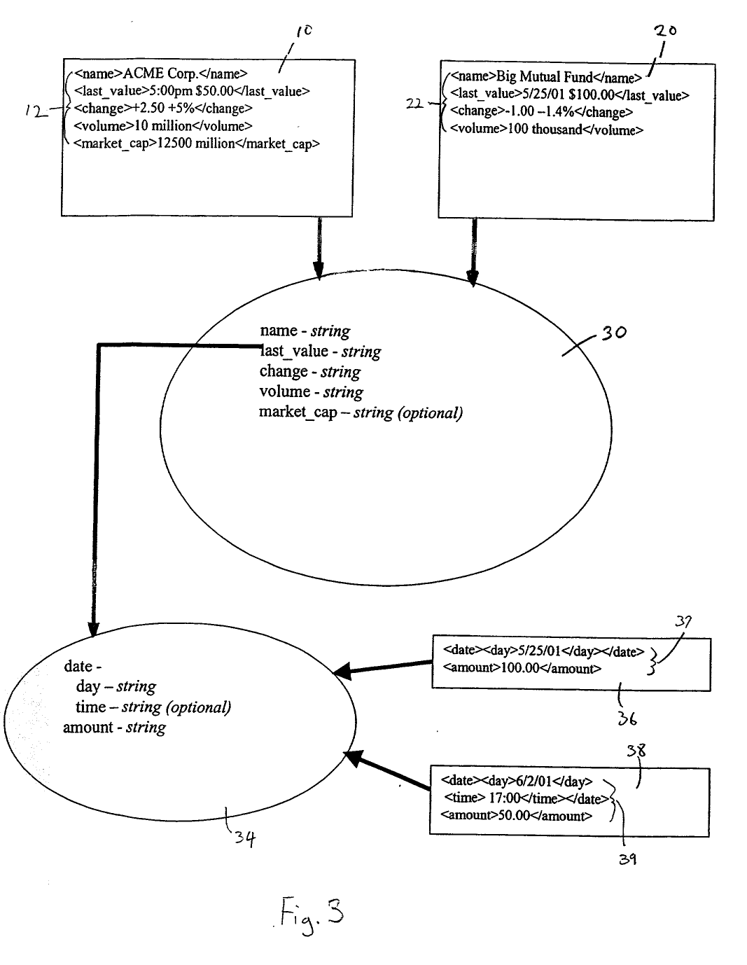

FIG. 2 illustrates the first example document 10 and a second example document 20 as well as plurality of other example documents 11 and 21 which may be associated with the first and second example documents 10 and 20 respectively. These plural example documents have at least one data element with the data element definition in the manner described above. For instance, one or more of the example documents 11, 20 and 21 may have various data elements such as all or only a few of those shown in FIG. 1 as well as other data elements which are not present in the first example document 10. As previously noted, the example documents 10, 11, 20 and 21 may be any type of documents including input documents or output documents. These documents are used in the manner described below to allow transformation of input data to output data.

FIG. 3 schematically illustrates how the first example document 10 and the second example document 20 are used to obtain a pattern set 30 in accordance with one embodiment of the present invention. In this regard, the data element definition including element name 14 and structure 16 of each data element in the first example document 10 is initially determined. Then, the data element definition including element name 14 and structure 16 of each data element 22 in the second example document 20 is also determined. As can be seen in FIG. 3, the second example document 20 contains data elements 22 that are associated with a stock transaction of a company called “Big Mutual Fund.” The data element definitions of the first example document 10 and the second example document 20 are then correlated to obtain the pattern set 30 that includes the data element definitions encompassing both example documents 10 and 20. Consequently, although only the first example document 10 includes the data element definition having the element named “market_cap”, this data element definition is included in the pattern set 30 as shown.

The correlation of the data element definitions of the first example document 10 and the second example document 20 means that if one document includes a data element definition not present in the other document and not already present in the pattern set, it is added to the pattern set 30 so that the pattern set 30 includes all the data element definitions provided by each of the example documents. This step of correlation is preferably attained by initially correlating the example documents correlating the data element definitions into sets of data element definitions having the same element name 12 and then adding to the pattern set 30 those data element definitions which are not present in the other document or the pattern set 30. In addition, with respect to data element definitions in which a name is provided with more than one structure, the generation of the structure for each set of data element definitions is based on general rules as follows:

1. If all of the structures in the corresponding set of data element definitions are the same, a structure that is the same as the structures in a corresponding set of data element definitions is generated.

2. If not all of the structures in the corresponding set of data element definitions are the same, a structure that is a union of the structures (i.e. a structure that is generic) in a corresponding set of data element definitions is generated.

In the present example where additional example documents 11 and 12 are also provided as shown in FIG. 2, the above described determination and correlation of data element definitions is iteratively repeated for these example documents and the pattern set 30 is revised accordingly to thereby provide a pattern set 30 that includes the data element definitions encompassing the example documents 10, 11, 20 and 21.

In addition, another pattern set referred to herein as “sub-pattern set” may be utilized to further refine one or multiple data element definitions in the pattern set 30. The phrase “sub-pattern set” as used herein refers to a collection of data element definitions associated with one or more data element of a pattern set to allow for a hierarchical expansion of the pattern set. A sub-pattern set 34 is illustrated in FIG. 3, the sub-pattern set 34 being derived in a similar manner as the above described pattern set 30 but being derived from XML fragments 36 and 38. The fragments 36 and 38 may be complete example documents or portions of one or more example documents, for instance, the example documents 11 and/or 21 of FIG. 2. The data element definitions of the data elements 37 and 39 of the fragments 36 and 38 respectively, are determined and correlated to generate sub-pattern set 34. In the illustrated example, it can be seen that the sub-pattern 34 is associated with the data element definition of the element named “last_value” of the pattern set 30. In this regard, the sub-pattern 34 is used to refine the data element definition of the element named “last_value” of the pattern set 30 and may be nested therein to provided data element definitions of sub-elements named “date” and “amount”, the sub-elements named “date” having its own nested sub-elements named “day” and “time.” By providing such sub-elements, the data string of a data element and correspondingly, the pattern set 30, is expanded.

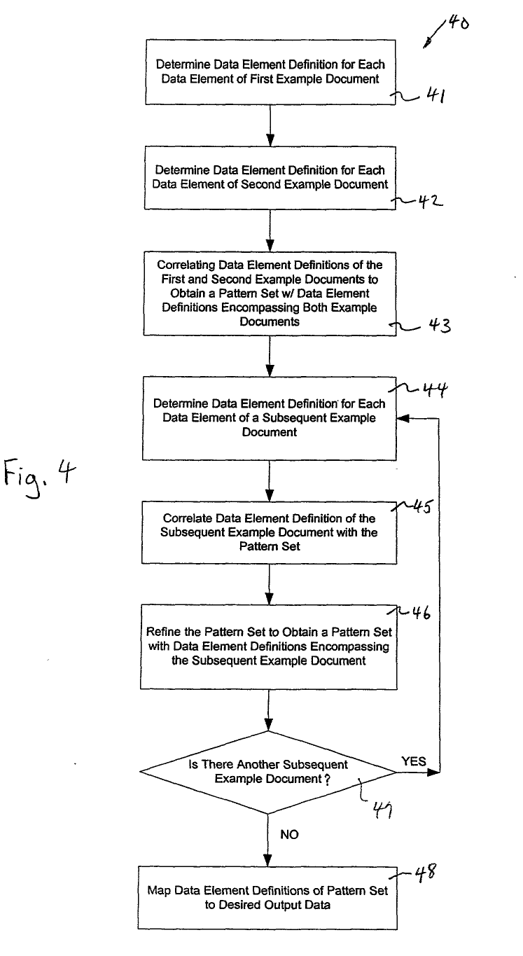

FIG. 4 shows a flow diagram 40 schematically illustrating the method in accordance with one embodiment of the present invention for defining a desired transformation from input data to output data from plural example documents that have data elements as described above. The method includes step 41 in which a data element definition including an element name and a structure is determined for each data element of a first example document. The data element definition of a second example document is determined in step 42, including element name and structure for each data element. These data element definitions of the first and second example documents are correlated in step 43 to obtain a pattern set with data element definitions encompassing both example documents. In step 44, data element definition of a subsequent example document is determined, including structure and element name for each data element. The determined data element definitions of the subsequent example document is then correlated with the pattern set in step 45. The pattern set is refined in step 46 to obtain a pattern set with data element definitions encompassing the subsequent example document as well as the first and second example documents. In decision step 47, it is determined whether another subsequent example document is provided. If another subsequent example document is not provided, the data element definitions of the pattern set are mapped to desired output data in step 48. However, if another subsequent example document is provided, then step 44 through 47 are iteratively repeated. The data element definitions of the pattern set are then mapped to desired output data in step 48.

As previously described, the correlating steps 43 and 45 are attained in one embodiment of the present invention by correlating the data element definitions into sets of data element definitions having the same element name, and then generating a structure for each set of data element definitions having the same element name which encompasses all of the structures in the corresponding set of data element definitions. As also previously described, the subsequent example documents may be used to refine the pattern set in step 46. Moreover, sub-pattern sets as described relative to FIG. 3 can also be used to refine the pattern set in step 46.

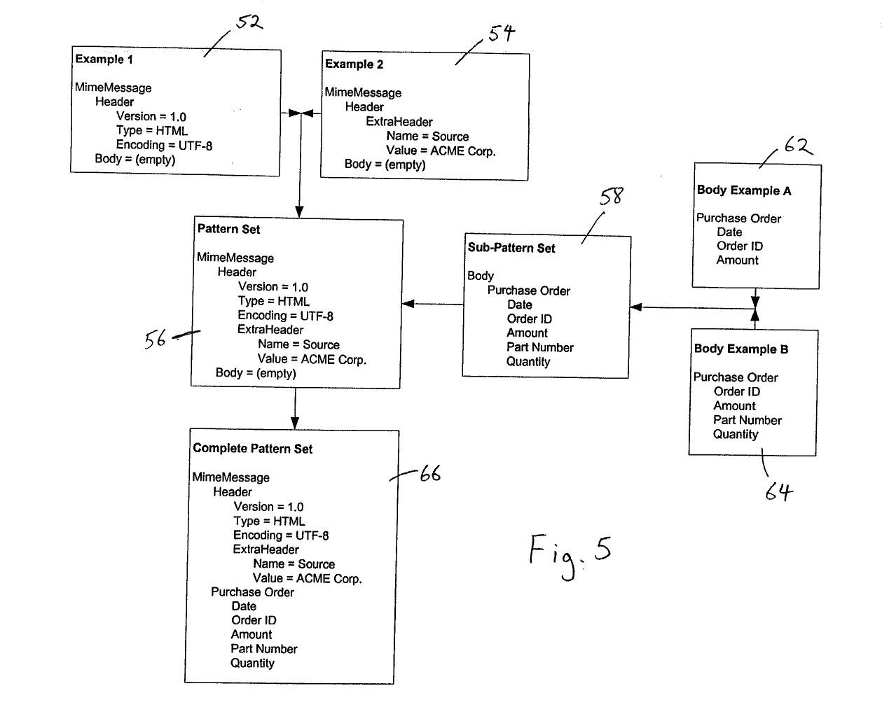

FIG. 5 also schematically illustrates another example of how the present method in accordance with the present invention is used to provide a pattern set where the example documents are multi-purpose internet mail extension (MIME) messages. In this example, a first example document 52 which is a MIME message is shown having a Header and data elements having the names “Version”, “Type”, and “Encoding”, as well as another data element having the name “Body” which is not defined in the first example document 52. In a similar manner, the second example document 54 has a Header and data elements having data element names “ExtraHeader” and “Body”, the data element definition of the element named “ExtraHeader” having sub-elements named “Name” and “Value” nested therein.

In accordance with the present method, the data element definitions the first and second example documents 52 and 54 are determined and correlated to obtain the pattern set 56. Thus, as can be seen in the pattern set 56, the data element definitions including the names and structures of example documents 52 and 54 have been combined so that the resulting name and structure is a union of the two example documents and the resulting names and structures are generic to both example documents 52 and 54. In this regard, data element definitions including the respective names and structures have been combined to thereby provide a pattern set having data elements named “Version”, “Type”, “Encoding”, and “ExtraHeader”, the element named “ExtraHeader” having its own sub-elements named “Names” and “Value”.

The illustrated example of FIG. 5 also shows the generation of a sub-pattern 58 having data elements which is used to expand the data element named “Body” of the pattern set 56. The sub-pattern 58 is derived from Body Example A 62 and Body Example B 64 which may be actual example documents or segments thereof. In this regard, Body Example A 62 includes data elements named “Date”, “Order ID”, and “Amount”. Body Example B 64 shows similar data elements but excludes the data element named “Date” while including data elements named “Part Number” and “Quantity”. Thus, with the data element definitions of the Body Example A 62 and Body Example B 64 being determined, they are correlated in the present example to provide the sub-pattern 58 having the union of the names and structures of the two examples so that the names and structure of the sub-pattern 58 are common (i.e. generic) to both of the examples. Thus, as can be seen, the sub-pattern 58 has the resultant data element definitions with names “Purchase Order”, “Date”, “Order ID”, “Amount”, “Part Number”, and “Quantity”.

In the illustrated embodiment of FIG. 5, the sub-pattern 58 is then correlated with the pattern set 56 in accordance with the present invention to provide the complete pattern set 66 which has been refined by the sub-pattern 58. Thus, the data element definition of the data element named “Body” of pattern set 56 has been expanded by the sub-pattern set 58 in the manner shown so that data element definitions of the data elements with the names “Purchase Order”, “Date”, “Order ID”, “Amount”, “Part Number”, and “Quantity” are provided in the sub-pattern 58. Of course, it should again be noted that the above is merely an example of the present invention as applied to MIME messages and the present invention may also be readily used in other applications as well.

It should also be evident from the discussion above that in accordance with the present invention, a pattern set derived from correlation of one set of documents may serve as a sub-pattern set of another pattern set, which in turn, may be a sub-pattern set of yet another pattern set. Thus, the above hierarchy of the terms name and structure of the data element definitions are used herein are merely used to convey the relationship of data element definitions in which the structures of the data elements are nested under a name. However, it should also be evident that sub-elements having their own data elements may be nested under data elements and thus, a data element may be considered as a name with respect to the data elements nested thereunder, but be considered as structure to the extent that it is itself, nested under another data element.

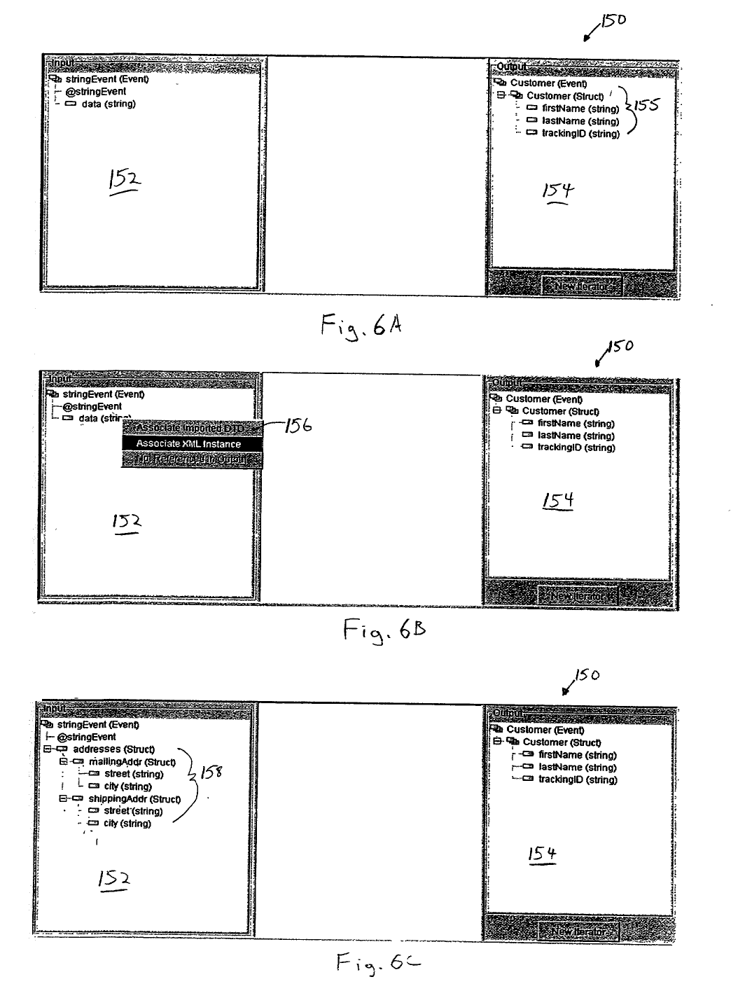

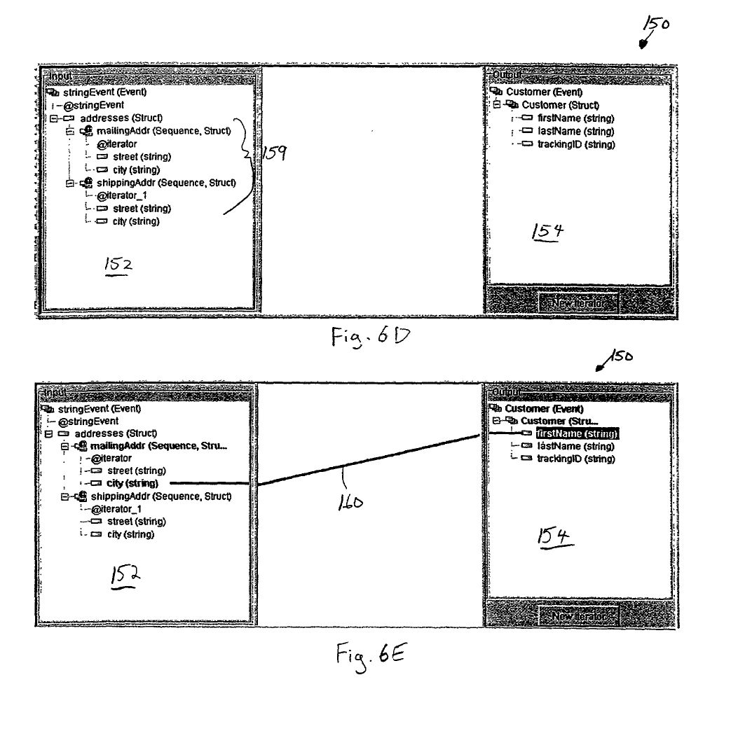

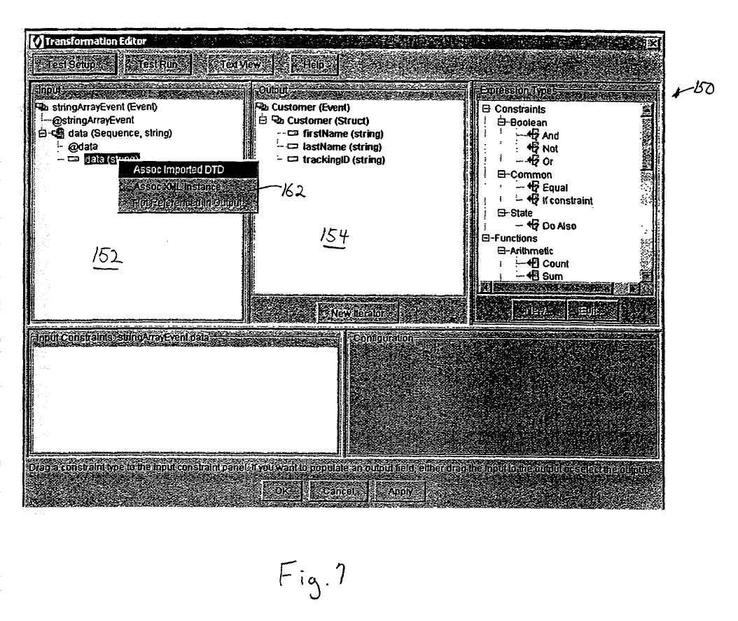

The above described method in accordance with the present invention is preferably implemented using a computational device such as a programmable general purpose computer, a special purpose computer, or the like. In this regard, the present method may be readily embodied as a software program executable on such computational devices that is provided on a data storage media such as magnetic or optical media including disks, CDs, DVDs etc. FIGS. 6A to 6E illustrate one example use of the present method which is implemented using a programmable general purpose computer, the application being in the context of customer information.

FIG. 6A shows a user interface of a graphical transformation tool 150 that enables non-programmers to define desired transformations from input data to output data. The graphical transformation tool 150 includes an input field 152 for processing and displaying input data, and an output field 154 for displaying the desired output data 155. In FIG. 6A, no pattern set has yet been defined for transforming the input data. In FIG. 6B, the user of the graphical transformation tool specifies that a pattern set is to be used for the input data by selecting “Associate XML Instance” from a pop-up menu 156 which may be displayed by right clicking a mouse (not shown). FIG. 6C shows the data element definitions 158 displayed in the input field 152 including element name and structure of a pattern set (not shown) which has been obtained using an example document in the manner previously described. In this regard, the original input data field has been expanded by the pattern set derived from the example document. FIG. 6D shows the data element definitions 159 from of a pattern set in the input field 152, the pattern set having been revised by a second example document in the manner previously described. FIG. 6E shows the user of the graphical transformation tool defining a transformation map 160 between the input data of “city” in the input field 152 to an output data of “firstName” in the output field 154 as indicated by the line connecting these data elements.

FIG. 7 illustrates a feature which may be incorporated into another embodiment of the graphical transformation tool 150 described above which utilizes the method of the present invention. In certain applications, the data string of the data element may be an XML document or documents. In particular, multi-part multi-purpose internet mail extensions (MIME) is emerging as a standard way of electronically sending multiple XML documents as a single packaged unit. This means there are instances where the data strings between the element names of a data element definition includes one or more complete XML documents.

In such cases, the user of the graphical transformation tool 150 may want to indicate to the graphical transformation tool that the string is really an XML document and utilize the graphical transformation tool 150 to access the data elements of the XML document in a manner as the previously described. In addition, the user of the graphical transformation tool 150 may desire to skip over some data strings or documents associated thereto, while manipulating some other data strings or documents. To facilitate such action, the graphical transformation tool 150 is provided with a pop-up menu 162 that can be displayed by right button clicking of a mouse (not shown) which allows the user to override the data string with either a document type definition (DTD) imported into the graphical transformation tool or a sample XML document from a disk.

One reason for allowing users to use a DTD or a predetermined sample XML document is that as XML documents become more and more complex, it becomes increasingly difficult to exhaustively map all permutations and combinations of every possible document. In such cases, the user of the graphical transformation tool 150 can elect to utilize a predetermined DTD or a predetermined sample XML document which are provided with data element definitions with element names and structures, as well as sub-elements, that are likely to be found in the example documents. Upon the user's selection of either the DTD or the predetermined sample XML document, the graphical transformation tool 150 replaces the data string or XML documents associated thereto with the data element definition extracted from the selected DTD or the predetermined sample XML document.

It should be noted that the above described DTD or the predetermined sample XML document should be considered as one type of the example documents which may be used in obtain the pattern set in the manner of the present method as previously described. The only significant difference is that the data element definitions provided in the DTD and the predetermined sample XML document would be predetermined whereas in the previous discussion, the data element definitions were determined and used to obtain the pattern set. Consequently, such a DTD and predetermined sample XML documents used as herein described should be understood to be within the scope of the present invention as well.

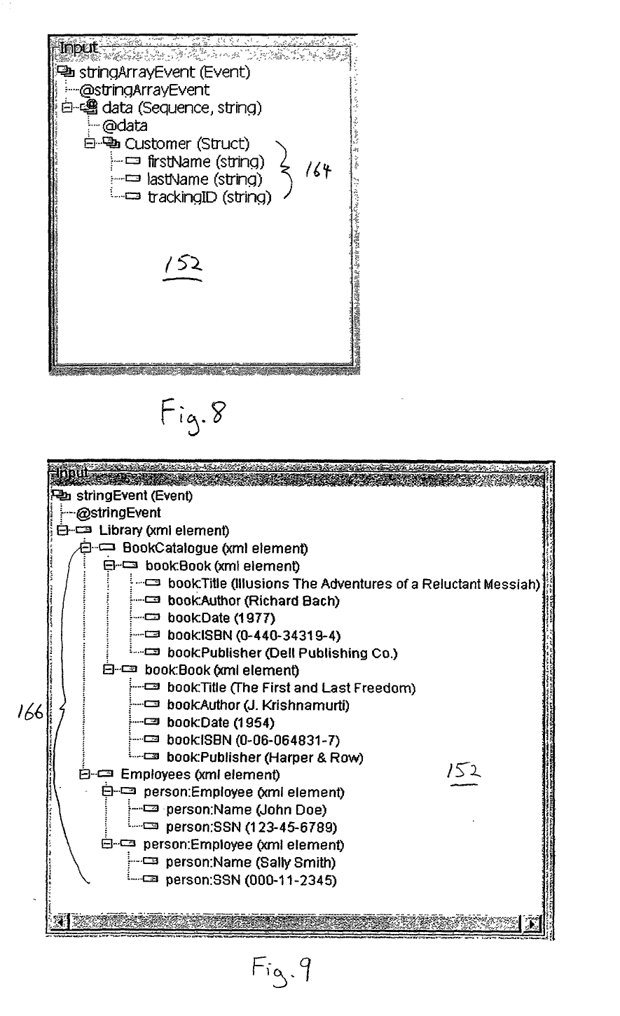

FIG. 7 shows an instance where the user utilizes a DTD imported into the graphical transformation tool 150 by selecting “Assoc Imported DTD” from the pop-up menu 162. In this regard, it should be noted that the DTD may be saved on the computational device implementing the present method. As shown in FIG. 8, once selected, the data element definitions 164 of the DTD as well as any sub-elements nested there under are displayed in the input field 152 instead of the data string. Then, the data element definitions 64 are accessible and usable to define a desired transformation to output data in the same manner previously described.

Similarly, as exemplified in FIG. 9, in a situation where a predetermined sample XML document is used, the input field 152 of the graphical transformation tool 150 displays the data element definitions 166 of the predetermined sample XML document and sub-element definitions nested therein instead of the data string. The user of the graphical transformation tool 150 can then add or remove data element definitions 166 as well as sub-elements definitions that are nested by using an input device such as a mouse (not shown). In addition, the data element definitions 164 can be used to define a desired transformation to output data in the same manner previously described.

It should now be evident how the present invention provides a method and apparatus for defining a desired transformation by using a pattern set obtained through example documents instead of schemas thereby avoiding the disadvantages associated with use of schemas. Whereas the above described applications of the present invention focused on stock transactions, customers, purchase orders, book catalogs, and in particular to XML documents, the present invention is not limited thereto but may also be applied to any other applications which utilize other types of documents with corresponding data elements. In this regard, the example documents used to derive the pattern set as described above may be any type of documents including, but not limited to, input documents and/or output documents used in any context or application. For instance, the present invention may be applied to EDI documents or other documents, etc. In such an application where EDI documents are used, element names may be defined by an external document such as a data dictionary.

While various embodiments in accordance with the present invention have been shown and described, it is understood that the invention is not limited thereto. The present invention may be changed, modified and further applied by those skilled in the art. Therefore, this invention is not limited to the detail shown and described previously, but also includes all such changes and modifications as defined by the appended claims and legal equivalents.

We claim:

1. A method of defining a desired transformation from input data to output data from plural example documents, each having at least one data element, the method comprising:
a) determining a data element definition including an element name and a structure for each data element of a first example document;
b) determining a data element definition including an element name and a structure for each data element of a second example document;
c) correlating the data element definitions of the first and second example documents to obtain a pattern set with data element definitions encompassing both example documents; and
d) mapping the data element definitions of the pattern set to desired output data.

2. A method as recited in claim 1, wherein said step (c) comprises:
c1) correlating the data element definitions into sets of data element definitions having the same element name; and
c2) generating a structure for each set of data element definitions having the same element name that encompasses all of the structures in the corresponding set of data element definitions.

3. A method as recited in claim 2, wherein said step (c2) comprises generating a structure that is the same as the structures in a corresponding set of data element definitions when all of the structures in the corresponding set of data element definitions are the same.

4. A method as recited in claim 2, wherein said step (c2) comprises generating a structure that is a union of the structures in a corresponding set of data element definitions when not all of the structures in the corresponding set of data element definitions are the same.

5. A method as recited in claim 2, further including the step of determining a data element definition including a structure and an element name for each data element of a third example document.

6. A method as recited in claim 5, further including the step of correlating the data element definitions of the third example document with the pattern set.

7. A method as recited in claim 6, further including the step of refining the pattern set to obtain a pattern set with data element definitions encompassing the third example document.

8. A method as recited in claim 7, wherein the step of refining the pattern set comprises the step of generating a sub-pattern set of a sub-element nested in a data element of the third example document.

9. A method as recited in claim 7, wherein the step of refining the pattern set comprises generating sub-elements to add structure to a data string of a data element, determining data element definitions of the sub-elements and generating a sub-pattern set based on data element definitions of the sub-elements.

10. A method as recited in claim 9, wherein the step of refining the pattern set further comprises the step of expanding the pattern set by integrating the generated sub-pattern set into the pattern set.

11. A method as recited in claim 1, wherein said first example document is at least one of an input document and output document.

12. A method as recited in claim 1, wherein said second example document is at least one of an input document and output document.

13. A method as recited in claim 1, wherein said first example document and said second example document are at least one of input documents and output documents.

14. A method of deriving a pattern set from plural example documents, each having at least one data element, the method comprising the steps of:
determining a data element definition of each data element in a first set of example documents;
generating an initial pattern set including the data element definitions from the first set of example documents;
determining a data element definition of a subsequent set of example documents; and
refining the initial pattern set to include data element definitions of the subsequent set of example documents.

15. The method of claim 14, wherein the data element definitions each include an element name and a structure.

16. The method of claim 15, wherein the step of refining the initial pattern includes the steps of correlating the data element definitions into sets of data element definitions having the same element name, and generating a structure for each set of data element definitions having the same element name that encompasses all of the structures in the corresponding set of data element definitions.

17. The method of claim 16, wherein the step of generating a structure includes generating a structure that is the same as the structures in a corresponding set of data element definitions when all of the structures in the corresponding set of data element definitions are the same.

18. The method of claim 16, wherein the step of generating a structure includes generating a structure that is a union of the structures in a corresponding set of data element definitions when not all of the structures in the corresponding set of data element definitions are the same.

19. A method as recited in claim 16, wherein the step of refining the pattern set comprises the step of generating a sub-pattern set of a sub-element nested in a data element of the subsequent example document.

20. A method as recited in claim 16, wherein the step of refining the pattern set comprises generating sub-elements to add structure to a data string of a data element, determining data element definitions of the sub-elements and generating a sub-pattern set based on data element definitions of the sub-elements.

21. A method as recited in claim 20, wherein the step of refining the pattern set further comprises the step of expanding the pattern set by integrating the generated sub-pattern set into the pattern set.

22. A method as recited in claim 14, wherein said first set of example documents includes at least one of an input document and an output document.

23. A data storage media with computer executable instructions for defining a desired transformation from input data to output data from plural example documents each having at least one data element, the data storage media comprising:
instructions for determining a data element definition including an element name and a structure for each data element of a first example document;
instructions for determining a data element definition including an element name and a structure for each data element of a second example document;
instructions for correlating the data element definitions of the first and second example documents to obtain a pattern set with data element definitions encompassing both example documents; and
instructions for allowing mapping of the data element definitions of the pattern set to desired output data.

24. The data storage media of claim 23, further including instructions for correlating the data element definitions into sets of data element definitions having the same element name, and instructions for generating a structure for each set of data element definitions having the same element name that encompasses all of the structures in the corresponding set of data element definitions.

25. The data storage media of claim 24, further including instructions for generating a structure that is the same as the structures in a corresponding set of data element definitions when all of the structures in the corresponding set of data element definitions are the same.

26. The data storage media of claim 24, further including instructions for generating a structure that is a union of the structures in a corresponding set of data element definitions when not all of the structures in the corresponding set of data element definitions are the same.

27. The data storage media of claim 24, further including instructions for determining a data element definition including a structure and an element name for each data element of a third example document.

28. The data storage media of claim 27, further including instructions for correlating the data element definitions of the third example document with the pattern set.

29. The data storage media of claim 27, further including instructions for refining the pattern set to obtain a pattern set with data element definitions encompassing the third example document.

30. The data storage media of claim 29, further including instructions for generating a sub-pattern set of a sub-element nested in a data element of the third example document.

31. The data storage media of claim 29, further including instructions for generating sub-elements to add structure to a data string of a data element, for determining data element definitions of the sub-elements and for generating a sub-pattern set based on data element definitions of the sub-elements.

32. The data storage media of claim 29, further including instructions for expanding the pattern set by integrating the generated sub-pattern set into the pattern set.

33. The data storage media of claim 23, wherein said first example document and said second example document are at least one of input documents and output documents.

34. A data storage media with computer executable instructions for deriving a pattern set from plural example documents having a plurality of data elements, the data storage media comprising:
instructions for determining a data element definition of each data element in a first set of example documents;
instructions for generating an initial pattern set including the data element definitions from the first set of example documents;
instructions for determining a data element definition of a subsequent set of example documents; and
instructions for refining the initial pattern set to include data element definitions of the subsequent set of example documents.

35. The data storage media of claim 34, wherein the data element definitions each include an element name and a structure.

36. The data storage media of claim 35, further including instructions for correlating the data element definitions into sets of data element definitions having the same element name, and generating a structure for each set of data element definitions having the same element name that encompasses all of the structures in the corresponding set of data element definitions.

37. The data storage media of claim 36, further including instructions for generating a structure that is the same as the structures in a corresponding set of data element definitions when all of the structures in the corresponding set of data element definitions are the same.

38. The data storage media of claim 36, further including instructions for generating a structure that is a union of the structures in a corresponding set of data element definitions when not all of the structures in the corresponding set of data element definitions are the same.

39. The data storage media of claim 36, further including instructions for generating a sub-pattern set of a sub-element nested in a data element of the subsequent example document.

40. The data storage media of claim 36, further including instructions for generating sub-elements to add structure to a data string of a data element, determining data element definitions of the sub-elements and generating a sub-pattern set based on data element definitions of the sub-elements.

41. The data storage media of claim 40, further including instructions for expanding the pattern set by integrating the generated sub-pattern set into the pattern set.

42. The data storage media of claim 34, wherein said first set of example documents includes at least one of an input document and an output document.
PARTS LIST

| | |
|---|---|
| 10 | first example document |
| 11 | other example documents |
| 12 | data elements |
| 14 | name |
| 16 | structure |
| 20 | second example document |
| 21 | other example documents |
| 22 | data elements |
| 30 | pattern set |
| 34 | sub-pattern set |
| 36 | fragments |
| 37 | data elements |
| 38 | fragments |
| 39 | data elements |
| 40 | flow diagram |
| 41 | step |
| 42 | step |
| 43 | step |
| 44 | step |
| 45 | step |
| 46 | step |
| 47 | step |
| 48 | step |
| 50 | graphical transformation tool |
| 52 | input field |
| 54 | output field |
| 55 | output data |
| 56 | pop-up menu |
| 58 | data element definitions |
| 59 | data element definitions |
| 60 | transformation map |
| 62 | pop-up menu |
| 64 | data element definitions |
| 66 | data element definitions |
